(19) United States
(12) Patent Application Publication
(10) Pub. No.: US 2009/0232160 A1
(43) Pub. Date: Sep. 17, 2009

(54) Bandwidth Requests of Scheduling Services

(75) Inventors: Yi Wu, Beijing (CN); Yan Qun Le, Beijing (CN); Dong Mei Zhang, Beijing (CN)

Correspondence Address: BRAKE HUGHES BELLERMANN LLP, c/o CPA Global, P.O. BOX 52050, MINNEAPOLIS, MN, 55402, US

(73) Assignee: Nokia Corporation, Espoo (FI)

(21) Appl. No.: 12/171,170

(22) Filed: Jul. 10, 2008

(30) Foreign Application Priority Data
Mar. 17, 2008 (EP) 08075201.7

(51) Int. Cl. H04J 3/16

(52) U.S. Cl. 370/468

(57) ABSTRACT

Methods and apparatus for providing bandwidth requests of scheduling services, such as, for example, best effort services, in a telecommunication network are disclosed. An example method includes receiving a plurality of bandwidth requests from different scheduling connections. The example method further includes combining the plurality of bandwidth requests in a common bandwidth request.

### CROSS REFERENCE TO RELATED APPLICATIONS

This application claims priority under 35 U.S.C. §119(a) to European Provisional Patent Application EP 08 075 201.7, filed on Mar. 17, 2008, and entitled “Bandwidth Requests of Scheduling Services.” The entirety of European Provisional Patent Application EP 08 075 201.7 is incorporated by reference herein.

### FIELD

This disclosure relates to a method and an apparatus for providing bandwidth requests of scheduling services in a telecommunication network. Moreover, the present disclosure relates to a computer program adapted to carry out such a method, and a network element of a telecommunication network comprising such an apparatus.

### BACKGROUND

Nowadays, in a telecommunications network a large number of services and applications are supplied to the customer. These are e.g. interactive services such as services on demand for providing speech and/or image services, services for transmitting data, internet services, telephone services as VoIP (voice over internet protocol) etc.

An intelligent resource management with QoS (quality of service) is needed to achieve a fair and adequate distribution of the available resources to customers, services and applications. By QoS, it is understood, e.g., that for an image or video connection, a higher transmission quality is needed than for a simple speech or audio connection. Therefore, the availability and reliability of the bandwidth both in the direction from a main frame of the service provider to the terminal of the customer or, more concretely, from a base station (BS) to mobile equipment (ME), and vice versa must be managed.

A predetermined QoS category is pre-allocated to each service and each application. Then a service is selected by a customer, e.g. by transmitting an appropriate request for supply of a service to a main frame, the main frame automatically makes a predetermined bandwidth available corresponding to the QoS category for the selected service. The bandwidth to be made available is usually rigidly predetermined for each service and each application in the direction from the main frame to the terminal of the customer and in the direction from the terminal of the customer to the main frame.

However, the consumption of the resources, in particular the uplink resource, is scalable within the base station and increases with the number users, which finally results in a higher collision probability over contention opportunities and in a slow-down of all the connections.

### SUMMARY

In an example embodiment, management of queuing scheduling services may be improved so as to reduce the collision probability and slow-down of the connections.

In order to achieve the above and the following, according to a first aspect of the present invention, there is provided a method for providing bandwidth requests of scheduling services in a telecommunication network, comprising combining bandwidth requests from different scheduling connections to one common bandwidth request.

In accordance with a second aspect, there is provided a computer program which is adapted to carry out methods according to the above mentioned first aspect.

In accordance with a third aspect, there is provided an apparatus for providing bandwidth requests of scheduling services in a telecommunication network, comprising means for combining bandwidth requests from different scheduling connections to one common bandwidth request.

Accordingly, example embodiments may effectively combine queuing bandwidth requests from different scheduling connections to one common bandwidth request. The combination of bandwidth requests from different scheduling connections does not influence the QoS (quality of service) scheduling at the base station because of independence from other QoS types having higher priority. In particular, such embodiments may be suitable for processing standalone bandwidth requests of best effort services.

Therefore, as proposed by the present disclosure, when bandwidth requests from multiple scheduling connections are combined, the collision probability is greatly reduced resulting in an enhancement of the performance.

From the point of view of implementation, the example embodiments described herein do not require any modification which would affect the scheduling services. Only a small part of a program is to be added in the process of bandwidth request handling. All definitions of the standards remain met, and the other components of the system are kept unaffected which results in good compatibility and easy deployment.

Further advantageous embodiments and modifications are defined in the dependent claims.

In an example embodiment, the scheduling services to be processed may be best effort services because there are no differentiated quality of service parameters among different best effort connections. The combination of bandwidth requests from different best effort connections does not influence the QoS (quality of service) scheduling at the base station because of independence from the other QoS types which have higher priority.

In particular, the telecommunication network may be a WiMAX (worldwide interoperability for microwave access) system.

In a further exemplary embodiment, a subsequent bandwidth request may be incorporated into a previous bandwidth request which is then kept as the one common bandwidth request.

In a still further exemplary embodiment, subsequent bandwidth requests may be incorporated into at least one previous bandwidth request which is then kept as the one common bandwidth request. In accordance with a modification of this embodiment, the subsequent bandwidth requests are incorporated into the previous bandwidth request which is then kept as the one common bandwidth request.

A number of bits of an uplink bandwidth requested by the subsequent bandwidth request may be added to that of the previous bandwidth request.

Moreover, the subsequent bandwidth request may be dropped after having been incorporated into the previous bandwidth request.

It has been found, in an example embodiment, that by incorporating or embedding the subsequent bandwidth request(s) into the previous bandwidth request, no essential information is lost, except for the connection ID (identity).

In a still further exemplary embodiment, the common bandwidth request maintains a back off process of contention resolution.

### BRIEF DESCRIPTION OF THE DRAWINGS

Example embodiments will now be described with reference to the accompanying drawing in which:

FIG. 1 is a schematic view of a WiMAX system according to an example embodiment;

FIG. 2 is a schematic block diagram of a mobile subscriber station showing the relevant functional components according to an exemplary embodiment; and

FIG. 3 shows a flowchart of a method according to an exemplary embodiment.

### DESCRIPTION

The IEEE 802.16 standard is designed to satisfy various demands for higher capacity, higher data rate, and more advanced multimedia services to residential and small business customers. This standard has many advantages, such as rapid deployment, high speed data rate, high scalability, multimedia services, and lower maintenance and upgrade costs.

FIG. 1 schematically shows a telecommunication network system having a WiMAX network architecture. Shown as an example is a base station BS defining a cell. Within this cell shown is a mobile equipment which operates as a mobile subscriber station SS. There is a radio link between the base station BS and the mobile subscriber station SS.

As shown in FIG. 1, the WiMAX network architecture further comprises an access service network gateway ASN-GW providing access to an access service network. A connectivity service network home agent CSN HA and a CSN AAA (connectivity service network authentication/authorization/accounting) are connected to the access service network gateway ASN-GW. Although not shown in FIG. 1, it should be added here that the base station BS includes a data processor, a memory which stores a program and a suitable radio frequency transceiver for bidirectional wireless communication with the mobile subscriber station SS, and that the mobile subscriber station SS includes a data processor, a memory which stores a program and a suitable radio frequency transceiver.

In order to support multimedia services with variable requirements of quality of service (QoS) in IEEE 802.16e or WiMAX (worldwide interoperability for microwave access) systems, an efficient scheduling algorithm has to be provided. Particularly, an efficient uplink (UL) scheduling algorithm for voice services is required because voice services are delay sensitive and have an important part in the multimedia services. As a leading technology for voice services in a packet oriented architecture, VoIP technology has been intensively investigated. In an IEEE 802.16e system, a subscriber station (SS) is provided to generate bandwidth requests so as to reserve uplink resources for different scheduling services to be classified. As to the scheduling services, there are five scheduling algorithms to support variable requirements of QoS in IEEE 802.16e systems: Unsolicited grant service (UGS), real-time polling service (rtPS), extended real-time polling service (ertPS), non-realtime polling service (nrtPS), and best effort service (BE). The UGS, rtPS and ertPS algorithms are designed to support real-time services, while the nrtPS and best effort algorithms are designed to support non-realtime services.

Of the five scheduling services mentioned above, the best effort scheduling service has the lowest priority. The intent of the best effort scheduling type is to provide efficient service for best effort traffic in the uplink. For correct operation of this service, a request-transmission policy is provided so that the subscriber station is allowed to use contention request opportunities. This results in the subscriber station using contention request opportunities as well as unicast request opportunities and data transmission opportunities. When a subscriber station needs to ask for bandwidth on a connection with best effort scheduling service, it sends a message to the base station with the immediate requirements of a DAMA (demand assigned multiple access) connection.

The best effort service is a non-realtime service with the lowest priority among all the scheduling services as defined in IEEE 802.16. Generally, the scheduling for the best effort service is based on an on-demand assignment, i.e. whenever the subscriber station has a best effort packet to transmit, it should first send a bandwidth request (BR) to the base station in order to get an uplink resource allocation in the subsequent frame. The bandwidth request can be sent by piggyback if there is any existing uplink flow. Otherwise, the subscriber station has to contend in the request contention opportunities.

In practice, the best effort service is very popular in the mobile Internet. For example, from the point of view of a web-browsing user, the scenario of multiple HTML (hypertext markup language) connections is quite common. Since all the best effort connections are based on an on-demand working mode, the traffic load caused by a bandwidth request is negligible. Therefore, the bandwidth request from different best effort connections may be queued at the subscriber station when the contention resolution or piggyback mechanism cannot provide enough opportunities for all of them. A “piggyback” process means that the bandwidth request message is not transmitted alone but piggybacked with (i.e. attached to) a data message in the reverse direction. Furthermore, the consumption of the uplink resource is scalable within the base station and increased with the number of users, which finally leads to higher collision probability over the contention opportunities and slows down all the connections.

In a WiMAX system, the bandwidth requests and grants are identified differently. For a subscriber service, the bandwidth requests refer to individual connections, i.e. each bandwidth request provides an individual transport connection identity (CID) of the connection which needs the uplink resource. However, as specified in the IEEE 802.16, each bandwidth grant is addressed to the subscriber station's Basic CID, not to individual CIDs. Since it is nondeterministic which request is being honored, the subscriber station should use the allocated uplink resource based on its own decision.

The subscriber service generates standalone bandwidth requests to reserve the uplink resources for different scheduling services which can be classified as rtPS, ertPS, nrtPS and best effort, whereas a UGS does not allow a standalone bandwidth request. If there is no available uplink transmission for piggyback or other unicast polling methods, the bandwidth requests have to be queued at the subscriber station and contend in the request contention opportunities, wherein however an rtPS does not allow a contention-based bandwidth request. Considering the access delay caused by the contention resolution process, it is quite possible that there are several new generated bandwidth requests queued at the subscriber station before the contending bandwidth request can be successfully transmitted, in particular if there are several parallel best effort connections running in the same subscriber station.

The high data rate support for multimedia services with different QoS types is one of the major advantages of a WiMAX system. Among all the QoS types, the best effort service is treated with the lowest priority and works based on an on-demand mode by sending a bandwidth request for temporary uplink resource reservation. Most of the bandwidth requests from best effort connections are sent out by contending the request contention opportunities. When the bandwidth requests from multiple best effort connections are combined, the collision probability is greatly reduced. This would not only enhance the performance of best effort connections, but also reduce the collision probability of bandwidth requests from other service types such as ertPS and nrtPS.

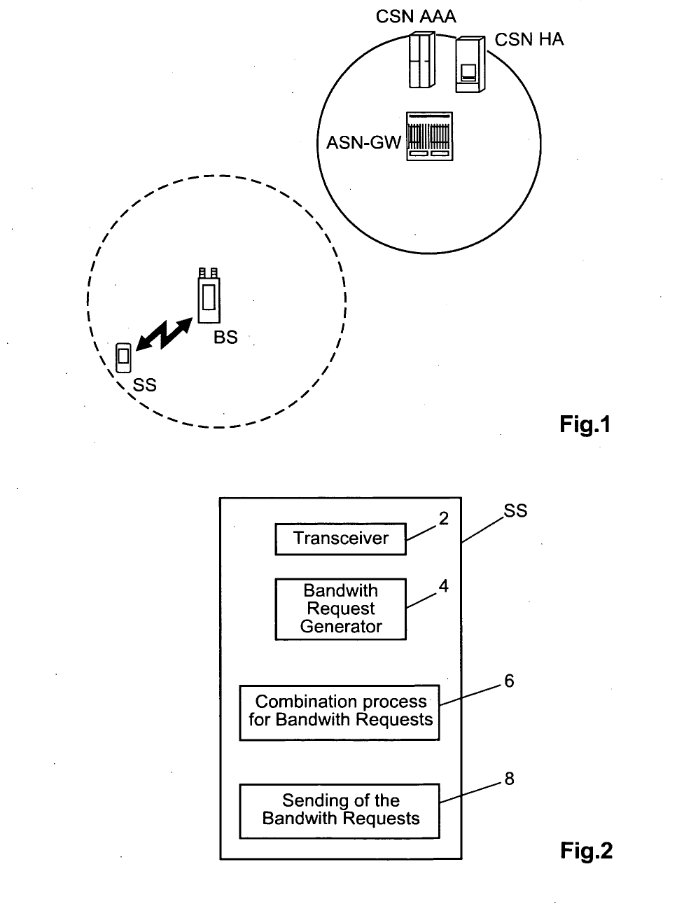

Therefore, the idea of the present embodiments is to effectively combine the queuing bandwidth requests from different individual best effort connections. FIG. 2 schematically shows a block diagram of a mobile subscriber station SS of FIG. 1 configured in accordance with an exemplary embodiment. FIG. 2 only shows those components in a block diagram which are relevant to the present discussion. These components include a transceiver 2 for receiving and transmitting signals and therefore define an interface. Further, the mobile subscriber station SS comprises a bandwidth request generator 4 for providing bandwidth requests. Still further, a processing unit 6 for carrying out a combination process for bandwidth requests is provided. Moreover, the mobile subscriber station SS comprises a unit 8 which prepares the sending of the bandwidth request via the transceiver 2.

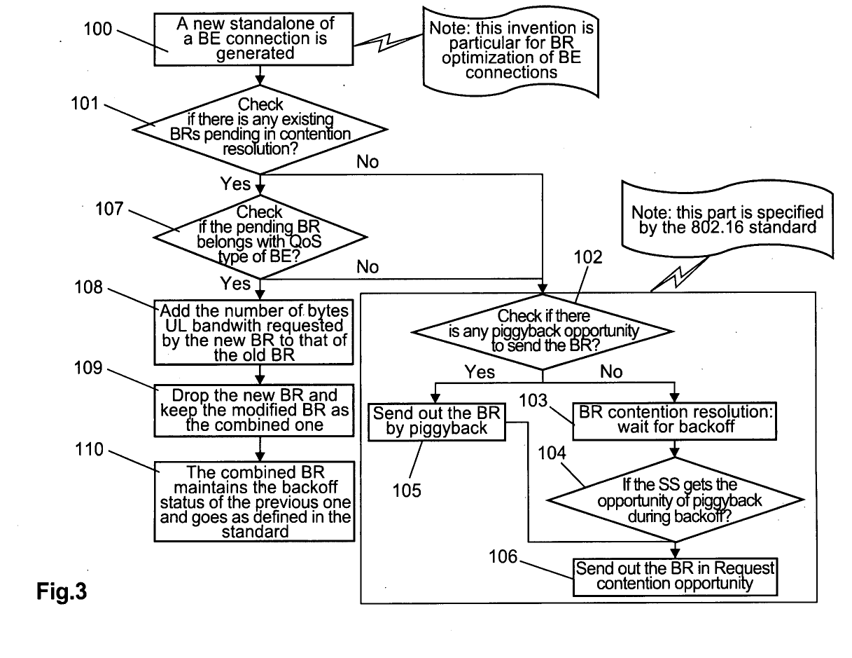

FIG. 3 shows a schematic flow chart of a method according to an exemplary embodiment, which method comprises the following steps:

1) The subscriber station holds a queue for standalone bandwidth requests waiting for opportunities to be sent to the base station for uplink reservation (step 100 in FIG. 3). According to the standard specification, the subscriber station first checks if there is any piggyback opportunity to send the bandwidth request (step 102 in FIG. 3). If there is no available piggyback opportunity, the bandwidth request enters the contention resolution process (step 103 in FIG. 3), i.e. defers several request opportunity slots based on a truncated binary exponential backoff algorithm. However, during the deferring period, if the subscriber station gets the opportunity of piggyback or other unicast polling (step 104 in FIG. 3), the contention resolution process will be terminated and the pending bandwidth request will be sent out by piggyback (step 105 in FIG. 3) or the unicast polling (step 106 in FIG. 3).

2) When a standalone bandwidth request which belongs to a best effort service is generated before entering the contention resolution process, the subscriber station first checks if there is any existing bandwidth request pending according to the backoff process of contention resolution (step 101 in FIG. 3).
2.1) If not, the process proceeds to above step 1).
2.2) If yes, then the subscriber station checks if the pending bandwidth request also belongs to a connection with a QoS type of best effort (step 107 in FIG. 3).
2.2.1) If not, the process proceeds to above step 1).
2.2.2) If yes, then a bandwidth request combination process is carried out as follows:
   a) The number of bytes of uplink bandwidth requested by the new bandwidth request is added to that of the pending bandwidth request (step 108 in FIG. 3). b) The new bandwidth request is dropped, and the modified bandwidth request is kept as a combined request (step 109 in FIG. 3).
   c) The combined bandwidth request maintains the existing backoff process, and the process proceeds to above step 1) (step 110 in FIG. 3).

In the exemplary embodiment as described above, the bandwidth request combination is only allowed for the best effort service because there are no differentiated QoS parameters among different best effort connections. In this way, to make the subsequent bandwidth requests embedded into the previous bandwidth request will not lose any other information except the CID. Since the bandwidth grants are not identified by the CID of the respective connection, but the Basic CID of the subscriber station, there is no difference for the subscriber station to handle the responding bandwidth grants. Furthermore, the aggregation of bandwidth requests from different best effort connections does not influence the QoS scheduling at the base station because of independence from the other QoS types which have higher priority.

The above described method may be implemented by computer software or by computer hardware or by a combination of computer software and hardware, preferably in the memory and processor of the mobile subscriber station.

Finally, it should be noted that the above described embodiments are given by way of example. However, the scope of the present subject matter should not necessarily be limited by the above description and also not necessarily delimited to WiMAX and IEEE 802.16e systems. The various embodiments described herein may be applicable to any type of wireless systems or wireless technology.

1. A method for providing bandwidth requests of scheduling services in a telecommunication network, the method comprising:
receiving a plurality of bandwidth requests from different scheduling connections; and
combining the plurality of bandwidth requests in a common bandwidth request.

2. The method according to claim 1, wherein the scheduling services are best effort services.

3. The method according to claim 1, wherein the telecommunication network is a WiMAX (worldwide interoperability for microwave access) network.

4. The method according to claim 1, wherein a subsequent bandwidth request is incorporated into a previous bandwidth request, which is then kept as the common bandwidth request.

5. The method according to claim 1, wherein subsequent bandwidth requests are incorporated into at least one previous bandwidth request, wherein the at least one previous bandwidth request is then kept as the common bandwidth request.

6. The method according to claim 5, wherein the subsequent bandwidth requests are incorporated into the previous bandwidth request, which is then kept as the one common bandwidth request.

7. The method according to claim 4, wherein a number of bits of an uplink bandwidth requested by the subsequent bandwidth request is added to that of the previous bandwidth request.

8. The method according to claim 4, wherein the subsequent bandwidth request is dropped after having been incorporated into the previous bandwidth request.

9. The method according to claim 1, further comprising maintaining a back-off process of contention resolution for the common bandwidth request.

10. A computer readable media having instructions stored thereon, the instructions, when executed by a processor, provide for:
receiving a plurality of bandwidth requests from different scheduling connections; and
combining the plurality of bandwidth requests in a common bandwidth request.

11. The computer readable media according to claim 10, wherein the instructions, when executed by a processor, further provide for incorporating a subsequent bandwidth request into a previous bandwidth request, which is then kept as the common bandwidth request.

12. The computer readable media according to claim 10, wherein the instructions, when executed by a processor, further provide for incorporating subsequent bandwidth requests into at least one previous bandwidth request, wherein the at least one previous bandwidth request is then kept as the common bandwidth request.

13. The computer readable media according to claim 12, wherein the instructions, when executed by a processor, further provide for incorporating the subsequent bandwidth requests into the previous bandwidth request, which is then kept as the one common bandwidth request.

14. The computer readable media according to claim 11, wherein the instructions, when executed by a processor, further provide for adding a number of bits of an uplink bandwidth requested by the subsequent bandwidth request to that of the previous bandwidth request.

15. The computer readable media according to claim 11, wherein the instructions, when executed by a processor, further provide for dropping the subsequent bandwidth request after having been incorporated into the previous bandwidth request.

16. The computer readable media according to claim 10, wherein the instructions, when executed by a processor, further provide for maintaining a back-off process or contention resolution for the common bandwidth request.

17. An apparatus for providing bandwidth requests of scheduling services in a telecommunication network, the apparatus comprising:
means for combining bandwidth requests from different scheduling connections in a common bandwidth request.

18. The apparatus according to claim 17, wherein the combining means is further configured to incorporate a subsequent bandwidth request into a previous bandwidth request and to provide the previous bandwidth request as the common bandwidth request.

19. The apparatus according to claim 18, wherein the combining means is further configured to add a number of bits of an uplink bandwidth requested by the subsequent bandwidth request to that of the previous bandwidth request.

20. An apparatus for providing bandwidth requests of scheduling services in a telecommunication network, the apparatus comprising:
a bandwidth request combiner configured to combine bandwidth requests from different scheduling connections in a common bandwidth request.

21. The apparatus according to claim 20, wherein the scheduling services are best effort services.

22. The apparatus according to claim 20, wherein the telecommunication network is a WiMAX (worldwide interoperability for microwave access) network.

23. The apparatus according to claim 20, wherein the bandwidth request combiner is further configured to incorporate a subsequent bandwidth request into a previous bandwidth request and to provide the previous bandwidth request as the common bandwidth request.

24. The apparatus according to claim 20, wherein the bandwidth request combiner is further configured to incorporate the subsequent bandwidth requests into at least one previous bandwidth request and to provide the at least one previous bandwidth request as the common bandwidth request.

25. The apparatus according to claim 24, wherein the bandwidth request combiner is further configured to incorporate the subsequent bandwidth requests into the previous bandwidth request and to provide the previous bandwidth request as the one common bandwidth request.

26. The apparatus according to claim 23, wherein the bandwidth request combiner is further configured to add a number of bits of an uplink bandwidth requested by the subsequent bandwidth request to that of the previous bandwidth request.

27. The apparatus according to claim 23, wherein the bandwidth request combiner is further configured to drop the subsequent bandwidth request after having been incorporated into the previous bandwidth request.

28. A network element of a telecommunication network, comprising:
a bandwidth request generator; and
a bandwidth request combiner operationally coupled with the bandwidth request generator, the bandwidth request combiner being configured to combine bandwidth requests from different scheduling connections in a common bandwidth request.

29. The network element according to claim 28, wherein the network element comprises a subscriber station.
